(19) United States
(12) Patent Application Publication
(10) Pub. No.: US 2026/0248597 A1
(43) Pub. Date: Aug. 27, 2026

(54) PROSTHETIC COMPONENT OF A DENTAL IMPLANT AND AN ABUTMENT FOR ITS SCREW RETENTION

(71) Applicant: OBSCHESTVO S OGRANICHENNOI OTVETSTVENNOSTYU "PLASMOVITA", MOSCOW (RU)

(72) Inventor: Vladimir Grigorevich Khantsis, Indianapolis, IN (US)

(21) Appl. No.: 18/856,209

(22) PCT Filed: Jun. 5, 2024
(86) PCT No.: PCT/RU2024/000178

§ 371 Date: Oct. 11, 2024

(30) Foreign Application Priority Data
Jun. 19, 2023 (RU) 2023116047

(51) Int. Cl. A61C 8/00

(52) U.S. Cl. CPC A61C 8/0068; A61C 8/0059

(57) ABSTRACT

A prosthetic component (3) of a dental implant (1) and an abutment (2) for its screw retention are related to the parts of a dental implant. The prosthetic component (3) comprises a fastening base (6) with a through hole (7) for a prosthetic screw (5). The base (6) is made with a connecting socket in the form of an annular recess (8) around the hole for the screw (7). The supporting lateral surfaces of the recess (8) are conical in shape, mutually coaxial and diverge outward. The abutment (2) comprises a seat for the fastening base (6) of the component (3). The seat is made in the form of an annular projection (22) around a threaded hole (21) for the screw (5). The supporting lateral surfaces of the annular projection (22) are conical in shape, mutually coaxial and converge outward. The tightness of the screw connection of the prosthetic component (3) with the abutment (2) is increased. Increased rotational stability of the component (3) relative to the abutment (2). Prevented loosening of the screw (5). Increased reliability of the screw connection. As a result, the risk of inflammatory reactions is reduced. Reduced risk of implant rejection (1).

### FIELD OF TECHNOLOGY

The invention relates to medical technology, namely to components of a dental implant system. The technical solution is intended for use in the field of orthopedic dentistry in prosthetic treatment with support on root-shaped endosteal implants.

### Previous Level of Technology

Currently, endosteal implants consisting of a root-shaped body, an abutment, a prosthetic component and an artificial crown have found wide practical application in restorative dentistry. The implant body serves as a support for the entire structure. The abutment carries a prosthesis or implant superstructure connected to the abutment through a prosthetic component, in particular a prosthetic cap.

From patent document TO 2006/0141419A1 dated 29 Jun. 2006, two types of dental implants are known: with cement or screw retention of the prosthesis. An implant with screw retention of the prosthesis consists, in particular, of an abutment for screw retention and a prosthetic component. This component includes in its design a flat fastening base with a through hole for the prosthetic screw. The abutment in turn contains a flat seat for the fastening base of the prosthetic component and a hole for the prosthetic screw, by means of which the prosthetic component is pressed against the abutment.

Implants with screw retention of the prosthesis have a number of advantages compared to implants based on cement retention. In particular, the prosthetic screw provides the possibility of a tighter mating of the connection surfaces due to their pressing against each other and maintaining the pressing force for a long time.

In addition, the threaded connection is disassemblable, which simplifies the installation and maintenance of the implant. Also, there is no need to remove excess cement around the abutment from under the gum, which is extremely difficult in the cramped conditions of the oral cavity. However, there is a risk that over time, the screw retention in the known device will weaken under the action of external forces applied to the implant. Micromovements of the implant parts will cause the suction of oral fluid into the cavities of the implant through leaks in the connection of its parts, which do not provide the necessary protection of the threaded pair due to the impossibility of achieving such a high mating density between the flat supporting surfaces as to ensure the tightness of the unit with the screw retention of the parts and its mechanical stability. Wetting the thread surface with oral fluid can reduce friction in the connection, which increases the likelihood of self-unscrewing of the prosthetic screw with a gradual increase in the amplitude of swinging of the parts until the screw fails.

In addition, the risk of loosening of the prosthetic screw increases due to the low rotational stability of the prosthetic component relative to the abutment due to the low value of dry friction between the flat supporting surfaces. At the same time, the known design does not have anti-rotation elements to prevent the prosthetic component from turning relative to the abutment.

Insufficient reliability of the screw connection causes the risk of peri-implantitis and even loss of the implant due to bacterial contamination.

### DISCLOSURE OF THE INVENTION

The technical problem is to provide greater reliability to the screw connection of the prosthetic component of a dental implant with its abutment and to reduce the risk of occurrence of inflammatory processes capable of leading to rejection of the root-shaped endosteal implant.

The provided positive effects of the invention consist, in relation to the solutions known from the prior art, firstly, in increasing the tightness of the screw connection of the prosthetic component of the dental implant with its abutment, and secondly, in increasing the rotational stability of the prosthetic component relative to the abutment with screw retention.

The above is achieved due to the following design implementation of the prosthetic component with screw retention for a dental implant. The fastening base of the prosthetic component contains a through hole for the prosthetic screw and a connecting socket in the form of an annular recess around the above hole. This recess is limited by a wall of small diameter and a wall of large diameter with supporting side surfaces of a conical shape, which are mutually coaxial and diverge outward.

In a particular case of implementing the invention, the rotation axes of the support side surfaces are coaxial with the longitudinal axis of the through hole for the prosthetic screw.

In another particular case, the annular recess is made from the condition of a lower height of the support side surface of small diameter relative to the support side surface of large diameter with the same conicity of these surfaces.

In a particular case, the annular recess is made with an anti-rotation element.

Also, the technical problem is solved, and positive effects are ensured, due to the fact that the seat of the abutment for the screw retention of the prosthetic component of the dental implant, intended for the fastening base of the said component, is made in the form of an annular protrusion around the threaded hole for the prosthetic screw. Moreover, this protrusion has external and internal support lateral surfaces of a conical shape, which are mutually coaxial and converge outward.

In a particular case, the axes of rotation of the support lateral surfaces are coaxial with the longitudinal axis of the threaded hole for the prosthetic screw.

Also, in a particular case, the annular protrusion is made from the condition of a smaller height of its internal support lateral surface relative to the height of the external support lateral surface with the same conicity of the said surfaces.

In another particular case, the annular protrusion is made with an anti-rotation element.

The implementation of a double protective conical connection of the parts around the threaded pair ensures, in particular, an increase in the density of the mating of the prosthetic component of the dental implant with its abutment with screw retention, which has a positive effect on the tightness of the screw connection to oral fluid, due to which the friction force in the thread does not decrease over time. An increase in the density of the mating of the prosthetic component with the abutment with their screw retention also leads to an increase in the rotational stability of the prosthetic component relative to the abutment due to the increased friction force between the prosthetic component and the abutment.

For uniform distribution of the load in the area of contact of the prosthetic component of the dental implant with its abutment with screw retention and achieving the highest density of the mating between them, the prosthetic component and the abutment are preferably made from the condition of coaxiality of the axes of rotation of the supporting lateral surfaces of the annular recess and protrusion relative to the longitudinal axis of the holes for the prosthetic screw.

When the annular recess and projection are equipped with anti-rotation elements, the rotation of the prosthetic component relative to the abutment is completely excluded, due to which the rotational stability of the prosthetic component is maximal.

### DESCRIPTION OF THE FIGURES OF THE DRAWINGS

The essence of the invention is explained by the following drawings, which show the design of the main components of the dental implant as a preferred example of implementing the technical solution.

FIG. 1: an assembled dental implant.

FIG. 2: a prosthetic component in the form of a cap.

FIG. 3: an abutment for screw retention of the prosthetic component.

FIG. 4-5: geometric parameters of the connecting socket of the prosthetic component and the seat on the head of the abutment.

### THE BEST VERSION OF THE INVENTION

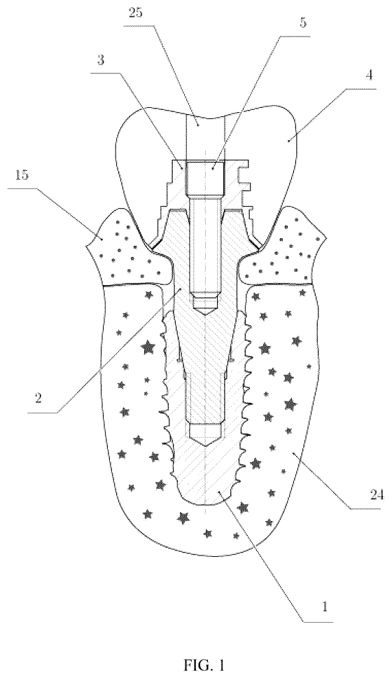

The presented implant is intended for replacing a jaw tooth. This implant consists of a number of parts, namely, an endosteal root-shaped body of the implant 1, a one-part abutment 2, a prosthetic component 3, an artificial single crown 4 and a prosthetic screw 5 (FIG. 1).

The prosthetic components are intended for fixing the prosthesis, in particular the crown 4 or the superstructure, on the abutment 2. The prosthetic component 3 in the form of a cap refers to prosthetic components with screw retention and is characterized by an internal cavity and a predominantly round cross-section.

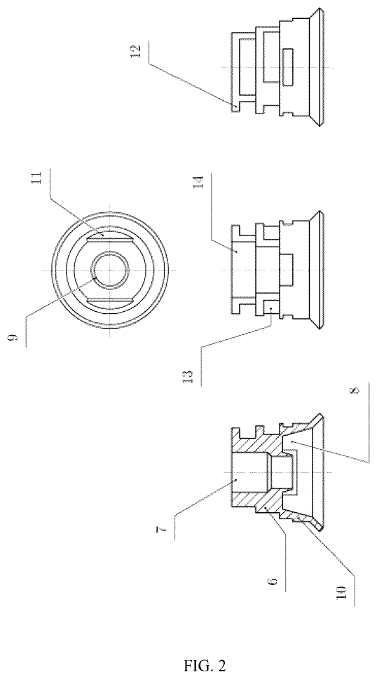

The body of the prosthetic component 3 comprises a fastening base 6, in the center of which a smooth through hole 7 is made for the prosthetic screw 5 (FIG. 2). The diameter of the hole 7 is selected from the condition of free passage of the threaded part of the prosthetic screw 5. On the side of the top of the prosthetic component 3, the channel of the hole 7 is expanded for the head of the screw 5. On the opposite side, the hole 7 communicates with the cavity of the connecting socket, intended for seating the prosthetic component 3 on the abutment 2.

The connecting socket of the prosthetic component 3 has the form of an annular recess 8 around the hole 7, limited by a wall of small diameter 9 and a wall of large diameter 10, made with a skirt.

These walls contain supporting side surfaces of a conical shape facing each other, located inside the prosthetic component 3. Moreover, the said surfaces are mutually coaxial and are made diverging outward. In this case, the rotation axes of the supporting side surfaces of the connecting socket coincide with the axis of the longitudinal opening 7 and with the central axis of the entire prosthetic component 3. The wall 10 of the annular recess 8 is made with a pair of internal anti-rotation elements 11 in the form of projections. On the outer surface of the prosthetic component 3, projections 12 are formed for cement fixation of the crown 4 or, if necessary, dental bridges and multi-support prostheses.

On the outer surface of the prosthetic component 3, grooves 13 are preferably made for holding the impression material when obtaining a dental impression, as well as edges 14, providing the possibility of using the prosthetic component 3 as an analog or digital impression transfer when manufacturing the crown 4.

The abutment 2 serves as an artificial tooth stump and provides support for the prosthetic component 3, as well as the formation of a gum ring 15.

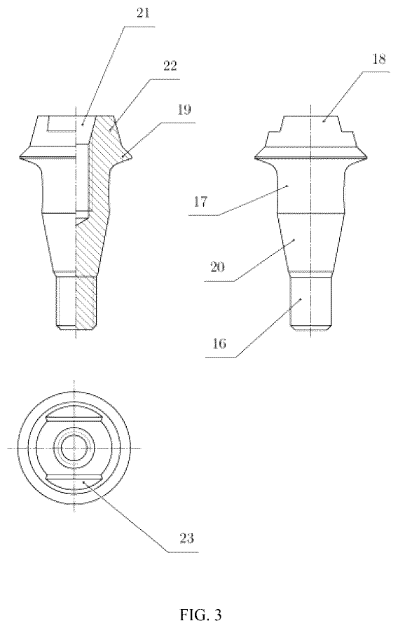

Abutment 2 has the shape of an elongated body of revolution, consists of a shank 16, a leg 17 and a head 18 (FIG. 3). The shank 16 is made with a threaded end part. The leg 17 is characterized by an axial narrowing, the value of which is selected from the condition of ensuring the restoration of the gingival cuff around the implant. Head 18 consists of gum former 19 and a seat for prosthetic component 3. Leg 17 is mated on one side with shank 16 through root conical part 20 of abutment 2. On the opposite side leg 17 is smoothly mated with gum former 19 of head 18. For prosthetic screw 5, head 18 and leg 17 have a mating blind threaded hole 21.

The seat on head 18 of abutment 2 is made in the form of an annular protrusion 22 with external and internal supporting side surfaces of conical shape. These surfaces are mutually coaxial and converge outward, forming the apical conical part of the abutment 2. Moreover, the axes of rotation of the conical-shaped surfaces and the longitudinal axis of the opening 21 coincide with the central axis of the abutment 2. The annular projection 22 is made with two external anti-rotation elements 23, which are chamfers, the size of which corresponds to the size of the build-ups on the wall 10 of the annular recess 8 of the prosthetic component 3. The seat on the head 18, in its geometric shape, is a mating part for the connecting socket of the prosthetic component 3.

The annular recess 8 of the prosthetic component 3 is made from the system of conditions (1).

$$\{ \begin{matrix}{H}_{c} > {h}_{c} \\ {α}_{H} = {α}_{h}\end{matrix} \qquad ( 1 )$$

### Where:

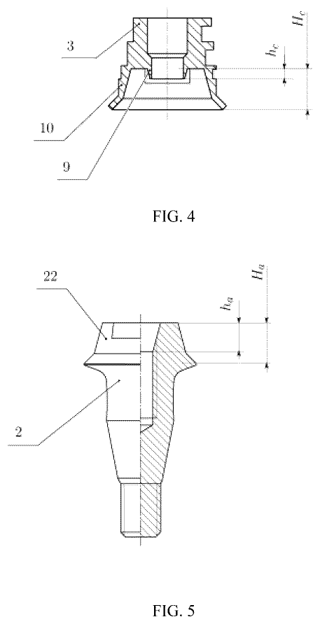

Hc—the height of the supporting side surface of the large diameter wall 10 of the annular recess (FIG. 4);
h_{c}—height of supporting side surface of small diameter wall 9 of recess;
αₕ—taper of supporting side surface of large diameter wall 10 of recess;
αₕ,—taper of supporting side surface of small diameter wall 9 of recess.

The values of parameters of annular projection 22 of abutment 2 satisfy system of conditions (2).

$$\{ \begin{matrix}{H}_{a} > {h}_{a} \\ {β}_{H} = {β}_{h}\end{matrix} \qquad ( 2 )$$

### Where:

H_{c}—height of the outer supporting lateral surface of the annular projection 22 (FIG. 5);
h_{c}—height of the inner supporting lateral surface of the projection 22;
β_{H}—taper of the outer supporting lateral surface of the projection 22;
βₕ—taper of the inner supporting lateral surface of the projection 22.

To ensure tight coupling of the cones of the prosthetic component 3 and the abutment 2 in relation to the annular recess 8 of the prosthetic component 3 and the annular projection of the abutment 2, the relationships of system (3) are valid.

$$\{ \begin{matrix}{H}_{c} \text{?} {H}_{a} \\ {h}_{c} \text{?} {h}_{a} \\ {α}_{H} = {β}_{H} \\ {α}_{h} = {β}_{h}\end{matrix} \qquad ( 3 )$$

$$\text{?} \text{indicates text missing or illegible when filed}$$

The execution of the annular recess 8 of the prosthetic component and the annular projection of the abutment, respectively, from the condition H_{c}>h_{c} and the condition H_{α}>h_{α}, ensures in the limited internal volume of the connection of these parts, part of which is occupied by the hole for the prosthetic screw, the possibility of observing the system of conditions aH=ah, βH=βh, the violation of which will lead to a decrease in the height of the internal cone or the size of its base, which will negatively affect the tightness of the screw connection and the rotational stability of the prosthetic component relative to the abutment.

The need to make a skirt on the wall 10 of the prosthetic component 3 is due to the expansion of the diameter of the head 18 of the abutment 2 for the gingiva former 19.

The endosteal part of the implant 1 is a mechanical replacement for the root of a natural tooth. An external screw thread is cut on the body of the implant 1 to ensure stability in the bone 24, and a central shaft with a conical neck and an internal connecting thread for fixing the abutment 2 is formed inside.

The implant parts are preferably made of a titanium alloy used in surgical products.

The assembly of this implant is carried out in the following sequence.

First, the endosteal body of the implant 1 is fixed inside the jaw bone. Then, the shank 16 of the abutment 2 is screwed into the central shaft of the body 1 to form a connection between the root conical part 20 of the abutment 2 and the conical neck of the said shaft.

Then, the prosthetic component 3 is temporarily placed on the head 18 of the abutment 2. In this case, the connecting socket of the fastening base of the body 6 of the component 3 is mounted on the seat of the head 18 of the abutment 2 with the support of the walls 9, 10 of the annular recess 8 on the annular projection 22. The implementation of the prosthetic component 3 and the abutment 2, respectively, with the annular recess 8 and the annular projection, the conical lateral surfaces of which are supporting each other over the entire contact area during screw retention of these parts due to the outward divergence of the conical surfaces of the prosthetic component 3 and the outward convergence of the conical surfaces of the abutment 2, while observing the condition of their coaxiality, ensures the formation of a double conical connection.

The possibility of retention of the prosthetic component 3 and the abutment 2 by the prosthetic screw 5 is ensured by the through hole 7 formed in the fastening base 6 of the prosthetic component 3 and the mating threaded hole in the body of the abutment 2. The prosthetic screw 5 is passed through the hole 7 in the body 6 and screwed in until it stops in the hole 21, due to which the prosthetic component 3 is pressed against the abutment 2. Using the grooves 13 or the edges 14 of the component 3, an analog or digital technological impression is made for the manufacture of a dental prosthesis. Next, screw 5 is unscrewed and component 3 is separated from abutment 2. The remains of the impression material are removed from grooves 13. Based on the resulting impression, crown 4 of a suitable shape with a through hole 25 for screw 5 is made.

Outside the oral cavity, prosthetic component 3 is cemented to the base of crown 4. Excess cement is completely removed from the area where the parts meet. The strength of the connection is ensured by the projections 12, which increase the adhesion of the cement to the outer surface of the prosthetic component 3. Then the prosthetic component 3 is again put on the head 18 of the abutment 2, but this time with the crown 4, and the previously described process of screw retention is repeated for the working pressing of the prosthetic component 3 to the abutment 2. In this case, component 3 is a holder for the base of the crown 4. The prosthetic screw is tightened with the force necessary to achieve tight contact between the walls 9, 10 of the annular recess 8 and the annular projection 22 along their entire diameter and mainly along the full height. If the crown 4 is made in advance, then the prosthetic component 3 is fixed on the head 18 of the abutment 2 immediately on a permanent basis.

As a final step, the input part of the hole 25 for the screw 5 in the crown 4 is sealed.

As a result, all the listed parts of the implant are connected to each other by assembly operations and are in a functional and structural unity. The crown 4 is rigidly connected to the body of the implant 1 through the prosthetic component 3 and the abutment 2.

The increased tightness of the screw connection and the increased rotational stability of the prosthetic component, the provision of which is not limited to the best embodiment of the invention, prevent loosening of the prosthetic screw and impart high reliability to the screw connection, reducing the risk of inflammatory reactions and implant rejection.

### LIST OF REFERENCE SYMBOLS AND FEATURES

1—implant;
2—abutment;
3—prosthetic component;
4—crown;
5—prosthetic screw;
6—fastening base;
7—through hole;
8—annular recess;
9—small diameter wall;
10—large diameter wall;
11—anti-rotation element in the form of a fillet;
12—projections;
13—grooves;
14—edges;
15—gum;
16—shank;
17—leg;
18—head;
19—gingiva former;
20—root conical part;
21—threaded hole;
22—annular projection;
23—anti-rotation element in the form of a chamfer;
24—bone;
25—hole in the crown.

1. A prosthetic component (3) with a screw retention for a dental implant (1), comprising a fastening base (6) with a through hole (7) for a prosthetic screw (5), characterized in that the fastening base (6) is made with a connecting socket in the form of an annular recess (8) around the hole (7) for the prosthetic screw (5), limited by a wall of small diameter (9) and a wall of large diameter (10) with supporting side surfaces of a conical shape, which are mutually coaxial and diverge outward.

2. The component (3) according to claim 1, characterized in that the axes of rotation of the supporting side surfaces of the walls (9, 10) are coaxial with the longitudinal axis of the through hole (7) for the prosthetic screw (5).

3. The component (3) according to claim 1, characterized in that the annular recess (8) is made from the condition of a smaller height of the supporting lateral surface of the small diameter wall (9) relative to the supporting lateral surface of the large diameter wall (10) with the same taper value of these surfaces.

4. The component (3) according to claim 1, characterized in that the annular recess (8) is made with an anti-rotation element (11).

5. The abutment (2) for screw retention of the prosthetic component (3) of the dental implant (1), comprising a seat for the fastening base (6) of the said component (3) with a threaded hole (21) for the prosthetic screw (5), characterized in that the seat is made in the form of an annular protrusion (22) around the hole (21) for the prosthetic screw (5), wherein this protrusion (22) has external and internal supporting lateral surfaces of a conical shape, which are mutually coaxial and converge outward.

6. The abutment according to item 5, characterized in that the axes of rotation of the supporting lateral surfaces are coaxial with the longitudinal axis of the threaded hole (21) for the prosthetic screw (5).

7. The abutment according to item 5, characterized in that the annular projection (22) is made from the condition of a smaller height of its internal supporting lateral surface relative to the height of the external supporting lateral surface with the same taper value of the said surfaces.

8. The abutment according to item 5, characterized in that the annular projection (22) is made with an anti-rotation element (23).
